(19) United States
(12) Patent Application Publication
(10) Pub. No.: US 2009/0158631 A1
(43) Pub. Date: Jun. 25, 2009

(54) Wave banner pole

(75) Inventors: Jon Christiansen, Batavia, IL (US); Spencer Christiansen, Batavia, IL (US)

Correspondence Address: Michael J. Femal;McDonald Hopkins LLC, Suite 590, 640 North LaSalle Street, Chicago, IL, 60610, US

(73) Assignee: J. C. Schultz Enterprises, Inc.

(21) Appl. No.: 12/004,898

(22) Filed: Dec. 21, 2007

(51) Int. Cl. G09F 15/00; G09F 17/00

(52) U.S. Cl. 40/607.04; 40/607.01; 705/14

(57) ABSTRACT

A television broadcasting system and methods that manages the insertion of targeted advertisements and other messages into live satellite or Internet broadcasts or other types of broadcasts into out-of-home locations such as health clubs. The insertion of targeted advertisement and other messages are accomplished by a satellite service provider purchasing live network broadcasting feeds with a license to strip out existing commercial advertisements and replace them with targeted advertisements to match the demographics of the viewing audience at health clubs and other non-home locations nationally, regionally and locally where the viewer is unable to change or delete the targeted advertisements while viewing the live broadcast programming from the networks.

### CROSS-REFERENCE TO RELATED APPLICATIONS

Not Applicable

### FEDERALLY SPONSORED RESEARCH OR DEVELOPMENT

Not applicable

### TECHNICAL FIELD

The invention relates generally to a system for displaying ads or promotional events on wave banners mounted to a wave pole that comprises a rotatable telescoping aluminum pole with a fiberglass whip that allows for constant visibility as well as quick and easy installation of different wave banners of varying sizes for outdoor or indoor advertising or promotion of businesses, sporting events and special occasions.

### BACKGROUND OF THE INVENTION

Today's society offers many ways to promote or advertise storefront businesses or special events. For example, people regularly view TV, newspapers or internet ads every day looking for a particular product or upcoming event. The question remains are these ads good enough to catch the attention of the average viewer or audience. Referring now to the average TV viewer, this person often tunes out any ad that they see on TV. In fact, many TV viewers' record programs on their various electronic devices associated with their TV and then skip over the commercials. These standard TV ad sources may be good enough for someone who likes to watch commercials but for a large segment of the TV viewing population, they are generally ineffective.

For people who are more active and always on the go, they tend to watch less TV and spend more time doing things outdoors. So, when people are taking a walk or jogging past a commercial district with storefront businesses or with upcoming event posters, the best outdoor advertising for instant visibility for the business or upcoming event would be a custom wave banner of a substantial size on a wave pole outside of the storefront or on the lawn adjacent the road or sidewalk next to the event. For a powerful impact to the passing viewer in an outdoor setting, a custom wave banner with a massive display creates an instant visual impact that can not be missed by the pedestrian walking or jogging past the storefront or event location. In this instance, a custom wave banner with a massive display carrying the advertising, promotional event or other information at the point of sale or event will have a more dramatic positive effect on bringing customer into store or on patrons attending the promoted event.

For example, today health clubs across the country commonly include unedited network and cable television programs or loop programming, which repeats over again with the same commercial advertisements each time. Generally, the younger viewing audiences at the health club who are working out in the clubs simply tune out repetitive commercial advertisements even for health club products like athletic shoes. Such ads are not effective because the ads play over and over again in canned loop programming. In fact, a common sight at health clubs with repetitive loop programming or even live broadcasting that regularly repeat commercials is that the viewing audience is often entertained by other devices, such as iPods®, cellular phones, and the like. The lack of attention paid to live broadcasting or looped programming by this potential customer audience represents a lost opportunity for advertisers to reach this desirable audience for their products or event.

Advertisers generally prefer to run advertisements to a targeted audience to match the advertisers' products and services. Advertisers also prefer to have advertisements displayed to individuals about whom there is some amount of demographic knowledge in a way that will have a powerful impact with a mass display. When purchasing advertising opportunities, a given advertiser might desire to have different advertising supplied to individuals of different age groups or living in different geographic locations. The custom wave banners mounted on a wave pole of the present invention accomplish all of these tasks.

In one example, a certain health club may have an audience that shares common demographic traits, such as generally being young, single, professional individuals with disposable income. Such a health club may be located in the downtown of a major city such as New York, Chicago, or Los Angeles. Advertisers would benefit from such a targeted audience by providing wave banners on wave poles with promotions related to products and services for sky diving, scuba diving, mountain climbing, skiing, and other such sport activities. Large indoor wave banners on wave pools mounted on multi-foot stand could greet the health club user as they enter the lobby of the health club.

In another example, a drugstore may cater to older individuals such as senior citizens. Such a drugstore may be located in a retirement community such as Sun City, Arizona or Lakeland, Fla. Advertisers would benefit from such a targeted audience by providing tall and colorful wave banners either indoors or outdoors with large readable text that is easily seen by older individuals in promoting related to products and services for pharmaceuticals and supplemental Medicare insurance. Advertisers would be interested in accessing such targeting of elder viewing audiences with custom wave banner promotions in these retirement communities. The large size custom wave banner is perfectly constructed to be used in the common areas of retirement communities by advertisers of products and services or even upcoming events. Senior citizens are more likely to notice the large and colorful banner and assimilate the ad information so the next time one is shopping, the banner advertising of the product or services will be remembered and the purchase of the advertiser's product or services is more likely.

Through the custom wave banner system and apparatus of the present invention, advertisers are assured that captive or friendly audiences and patrons at shopping malls, health clubs, retirement communities or walk in customers at storefront businesses are viewing their ads on the custom wave banner poles placed either indoors or outdoors near their respective facilities. This compares favorably to ads placed on TV media where the TV viewing audiences who watch TV programs and attendant commercials on a TiVo® or similar digital video recording systems are able to avoid viewing the advertisements simply by skipping or deleting the commercials altogether. Unlike viewers of broadcast television, custom wave banners provide a powerful and high impact impression on the potential customer with its massive colorful display in plain view at health clubs, retirement communities, storefront businesses, special events and other promotions or ads.

A potential problem with large custom wave banners mounted on poles used in outdoor settings is the wind associated with various weather conditions. The material used for making custom wave banners is usually nylon and makes a perfect sail material. If the wave banner is attached to a wave banner pole that is rigidly fixed in position, it might result in the sail effect. High winds might topple the wave banner and its support pole with a strong gust. In fact, the sail effect might damage the custom wave banner if the gust of wind is perpendicular to the wave banner that is rigidly held in place during a forceful wind condition created by a storm. It might tear or rip the wave banner.

The present invention is provided to solve the problems discussed above and other problems, and to provide advantages and aspects not provided by prior advertisement systems and methods that attempt to target a given audience in either an indoor or outdoor setting. A full discussion of the features and advantages of the present invention is deferred to the following detailed description, which proceeds with reference to the accompanying drawings.

### SUMMARY OF THE INVENTION

Currently, there is no other apparatus or system that is comparable to the present invention for a system utilizing a large and massive custom wave banner mounted onto a 360° rotatable telescoping pole for inserting colorful advertisements and promotion of events through a wave banner display having a powerful impact directed to select groups of people, such as health club members, retirement communities or storefront businesses.

In an embodiment of the present invention, an adjustable telescoping wave pole comprising a plurality of hollow tubular sections that are slideably received within each other, thereby allowing the pole to be extended and retracted to various predetermined lengths corresponding to the length and size of the wave banner mounted thereon. Each section has a first and second end. The first end is open to receive another tubular section within the opening that is slightly less in diameter than the opening and its second end includes a frictional mechanism for a lock twist of the second end within opening of the section that it fits into to hold it in a fixed relationship to its adjacent lower section. The sections are dimensioned to be movably and telescopically interconnected to one another and spaced apart in a lock twist relationship with respect to one another. The sections remain partially within each adjacent section whether full or partial extended with respect to each other while adjusting the overall length of the pole by the lock twist motion of the user. Each section includes a plurality of numerical height markings on the outer tubular surface of each section that corresponds to the exact numerical height markings on the other sections. So when a particular measurement in length is chosen to match the wave banner length, each section is telescoped with respect to the other sections to have the exact same numerical height marking on each section adjacent the opening into which each section fits to adjust the overall exact length of the wave banner pole its desired length.

The bottom section of the wave pole includes a pole section generally disposed in a vertical plane that rotates 360° within a base support to accommodate wind conditions when the wave banner pole is placed outdoors. When the wave banner pole is used indoors the same 360° rotation ability allows the user to rotate the pole to a certain position when placed indoors for maximum visibility for viewing by passing patrons. The 360° rotation of wave banner pole is achieved through a plurality of separate circular bearings affixed in a predetermined spaced apart relationship with respect to each other around the circumference of a rod affixed to and extending downwardly and axially from the bottom section of the pole for insertion into a base stand or support mechanism.

The rod with the bearings attached thereto is inserted in the base stand or support mechanism comprising in one embodiment a hollow base mounting tube in which the bearings outer circumferential surface bears on the inner circumferential surface of the base mounting tube for supporting the wave banner pole in a 360° rotational position for displaying colorful and custom wave banners mounted thereon suitable for use indoors or outdoors even in windy weather conditions. This allows the attachment of wave banners without the problem of wind shears tearing the banner or toppling over the wave banner pole.

The base stand or support mechanism for the wave banner pole comprises the hollow tubular member having openings at a first and second ends. The opening at the first end of the base hollow tube is circumferential large enough to just pass the circular bearings axially mounted on the rod therethrough into a close engagement with the inner circumference surface of the hollow tube. The second end includes a ridge stop just above its opening so that all of the bearings are within the hollow tube when inserting the rod and its bearings into the hollow tube and to engage the horizontal surface near the outer edge of the lowest circular bearing mounted on the rod to hold the telescoping pole securely in place with its rod and bearings within the hollow tubular base stand.

A threaded thumb screw hole is located just above the lowest bearing on the tubular base stand so a thumb screw can be threaded within the hole to engage with the surface of the rod to prevent the wave banner pole from pulling back out of engagement with the base stand when assembled in the base stand and being subject to wind forces or a patron passing by and grabbing the wave banner pole and trying to lift it out of its base stand. The base stand may also be attached to a plurality of horizontally disposed feet to support the hollow tubular stand in a generally vertical position or the base stand may be attached on its vertical side surface to a second rod or spike ending in a point for insertion into the ground. The horizontal feet would come into play within an indoor application of the wave banner or even outside of a business storefront. The spike attached to the base stand allows the wave banner pole to be used on boulevards, lawns, parks and other application having ground underneath and not a man made surface. The rod protrudes from the hollow base tube surface providing a platform to push the second rod into soft ground or to pound with a hammer or similar tool into hard ground for fixedly supporting the base stand in a generally vertically or perpendicularly disposed position with respect to the ground.

The custom wave banner pole of the present invention includes the unique 360° rotational feature in conjunction with its base support. Depending on the direction of the wind the wave banner pole will generally turn into the direction of the wind offering the least wind resistance and preventing the wave banner and the support pole from tipping over or being damaged by gusts of wind when placed outdoors.

Another feature provided by the unique swivel rotational movement of the pole mounted within its base support, is the constant visibility of the displayed ad or promotional messages thereon regardless of the wind conditions when placed outdoors. Obviously, if a violent storm or heavy rain is expected the wave banner and pole should not be displayed outdoors. The wave banner and pole system avoids the scourge found with advertisers just relying on TV ads where there is the ability of the viewer to change channels, skip commercials or time-shift their viewing to avoid ads. The technology of the present invention allows advertisers to create specific, market coverage patterns; position specific messages with large visible displays using color and eye-catching arrangements; and utilize all forms of high quality photo reproduction for sporting events, retail signage, special occasions and stock storefront business messages.

Advertisers can now display advertisements in the above mentioned locations in the form of the custom wave banners utilizing the wave banner pole of the present invention and as such the wave banners with their ads or promotion are often the first and last thing seen by a patron upon entering or leaving a business, club, park or other high traffic location. Typical poster boards or even bulletin boards, however, bury information amongst a lot of clutter of other information posted on the typical poster boards or bulletin boards placed around the typical business or recreational facilities without any particular focus. Moreover, patrons typical view poster or bulletin boards located in these businesses or facilities only for short period of time and may entirely miss the ad, promotion or event on such display boards. A custom wave banner mounted to a wave banner pole with its ad or event promotion stands out amongst such other clutter.

A custom wave banner and wave banner pole system on the other hand provides a large forum for outdoor/indoor advertising purposes and can be placed in high traffic areas such as alongside ingress or egress to storefronts, shopping centers, malls, clubs and busy roads. The custom wave banner and wave banner pole system with its massive, colorful wave banner ads thereon provides a large and visible advertisement to passing pedestrians and drivers alike. The wave banners typically show large, witty slogans and distinctive visuals that are highly visible for your business or event. Wave banners also afford the greatest visibility due not only to their size, but because they allow creative customizing through various colors and embellishments and go beyond the routine advertisements that are generally ignored by the public.

Therefore, the present invention with its unique 360° is an ad and event display delivery system suitable for many different applications that can be displayed either indoors or outdoors without any electricity or other infrastructure required to display the ads or event promotions. The custom wave banner and wave banner pole promote the products or services of the business with high attention getting wave banners of varying sizes. The wave banners may include ads that change daily, promote events that are national, regional, or local in scope with regard to the markets served. The ads or event promotions are generally placed on the wave banners depending upon the audience demographics targeted with meaningful advertisements that apply to specifically to the audience or patrons interests, buying habits, and lifestyle.

An embodiment of an apparatus and system of the present invention begins with an adjustable telescoping aluminum pole formed from a number of inter-received tubular members having a fiberglass whip at one end and a protruding elongated rod at the other end of the pole with three circumferential bearings spaced apart axially over the length of the rod axially extending from the bottom tubular member for rotationally receiving the bearings within a tubular support base. The tubular support base has an opening at one end to receive the rod with the bearings therein and a constricted opening at the other end to engage the lower most bearing toward its outer edge to hold the pole in a securely in its support base. The support base is mounted either to a vertical disposed pole stand having horizontal feet at the bottom for stability for use supporting on various man made surfaces like cement, tile or other floors within a facility. The support base can also include a rod or spike affixed to the tubular base support and extending downwardly a predetermined distance below the bottom tubular member of the pole within the support base and terminating in a ground penetrating point. The rod or spike attached to the side of the base support can be driven in to the ground by a user's foot or by a tool like a hammer for harder ground surfaces.

Each inter-received tubular members includes a frictional insert mechanism at its closed end. The wave banner pole of the present invention is directed to a support the wave banner with the ads, such as the custom banner that attaches to the wave pole in mere seconds or a minute or two. The wave banners are made of 200 denier nylon, screen printed single face reverse and come with a sleeve and tie down clip at the bottom of the sleeve to mount the banner on the pole. Depending upon the wave banner, the wave banner pole assemble includes a fiberglass whip at one end that bends to form the wave top of the banner and then extends downwardly into the top of the rigid telescoping aluminum members capable of assuming a variable longitudinal dimension, such as a several infinitely variable extended positions or a collapsed position for storage. The selectively variable length of the wave banner pole is accomplished by a plurality of member or sections cooperatively dimensioned and structured to be movably and telescopically interconnected to one another.

Accordingly, in a fully extended position, corresponding end portions of two adjacent members or sections come into registry with one another at their junctions. Additional structural features facilitate the at least temporary “locking” of the members or sections in their predetermined extended position. These additional structural features may include a somewhat conventional “twist lock” structure shown in prior art golf ball retrievers and the like. As such, relative orientation of adjacent, interconnected members or sections will cause a frictional engagement there between at the corresponding junctions between the members sufficient to maintain the members or sections in their desired extended position.

An alternative embodiment is wherein the junction between adjacent members comprises an interior circular hollow bushing having slits portions at one end thereof to engage a threaded bottom of each member terminating in a rounded point within the other adjacent member or like structure mounted on this one inner bottom end of each member or section of the wave banner pole. The slits of the bushing are dimensioned and configured to frictionally engagement interior surfaces of the corresponding end of the member or section as it is twisted in a certain direction causing the bushing to move up the threaded end of the each member causing slitted portion of each bushing to expand outwardly from the axis of the member or section to frictionally engage inner wall of the tube member or section encasing it. Accordingly, each of the adjacent inner connected members or sections is prevented from becoming detached from one another. Thus each member is also capable of temporarily locking adjacent ones of the members or section in their outwardly extended position due to the frictional engagement of the bushing slit portions with corresponding inner walls of the member or otherwise structured interior surface portions of each member provided at their junctions. As set forth above, the telescopic interconnection of the members or sections further allows the wave pole to be collapsed into a stored position for placement into a protective carrying case. In this position, each of the members or sections are disposed in concentric relation to one another, wherein the larger member having the greatest interior diameter will house and concentrically surround the additional and progressively smaller members going toward the fiberglass whip in the last member of the wave banner pole.

As generally stated above the frictional mechanism is comprised of several components. The bushing is generally screwed upwardly on threads on the bottom or base of each tubular member by twisting or rotating the smaller member within the larger member. There is also a screw with a washer axially screwed into the tapered or rounded threaded end of each member to prevent the bushing with its outwardly axially extending slits from completely coming off the threaded end of each member when twisted in the other direction to unlock the extending member and collapse it further into the larger member during storage.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an exemplary schematic illustration of a wave banner pole system of the present invention;

FIG. 2 is an exemplary schematic illustration of a base stand driven into the ground to support and receive the wave banner pole invention of FIG. 1;

FIG. 3 is a cross section along lines 3-3 of FIG. 2 of the ring clip to hold the wave banner of the present invention.

FIG. 4 is a cross section taken along 4-4 of FIG. 2 of the thumb screw for securing the wave banner pole within the base stand of the present invention.

FIG. 5 shows the interconnection of the wave banner pole members or sections with the unique rotational bearings and interlocking frictional mechanism of the present invention of FIG. 1

FIG. 6 is an exemplary schematic illustration of a frictional twist lock mechanism of the present invention between adjacent members of the wave banner pole of the present invention;

FIG. 7 is an exemplary schematic illustration of the frictional engagement of the bushing slits against the inner surface of the larger member or section when adjacent members are twisted into a locking position of the present invention;

FIG. 8 is an exemplary schematic illustration of the storage case of the wave banner pole.

### DETAILED DESCRIPTION

While this invention is susceptible of embodiments in many different forms, the drawings show and the description describes in detail preferred embodiments of the invention with the understanding that the present disclosure is to be considered as an exemplification of the principles of the invention and is not intended to limit the broad aspect of the invention to the embodiments illustrated.

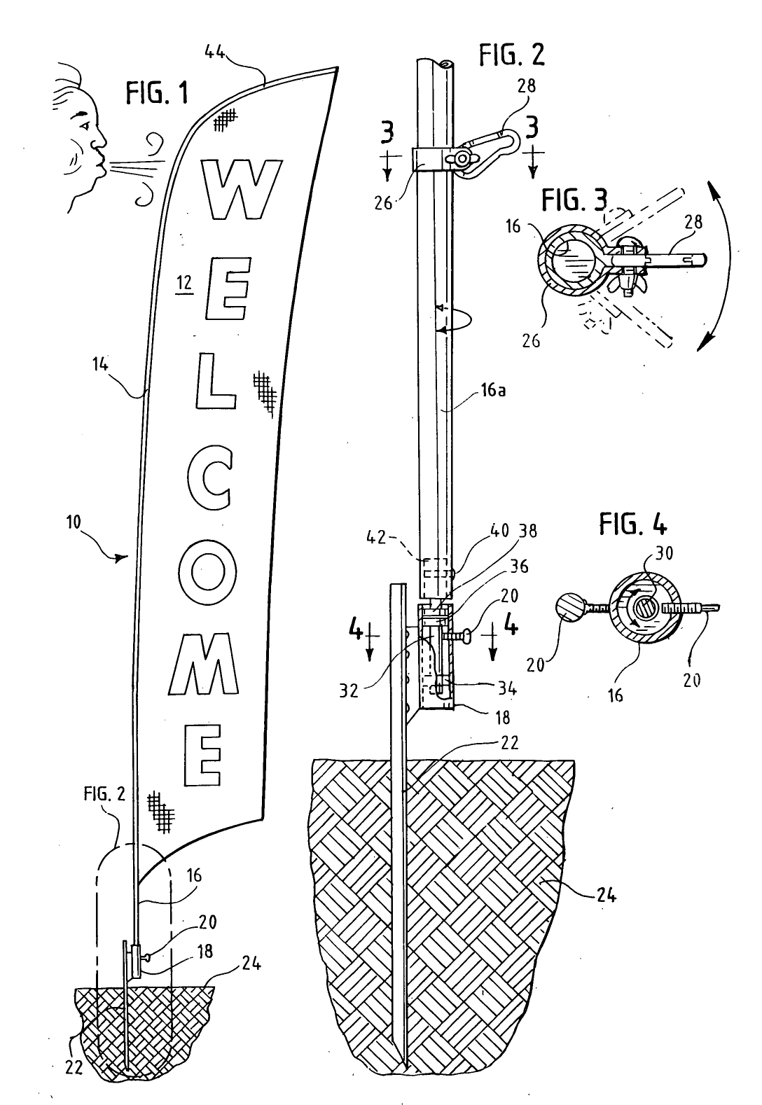

FIG. 1 illustrates an exemplary embodiment of a wave banner pole and system 10. Such a wave banner pole and system 10 may be used to mount custom wave banners 12 having a sleeve 14 for inserting a wave banner pole 16 therein to the predetermined length for displaying the large, colorful wave banner 12 bearing the particular ad or promoted event that is mounted within a base stand 18 and secured therein by a thumb screw 20 engaging the pole 16. A rod or spike 22 is affixed to the side of the base stand for securing the base stand 18 in a generally vertical position with respect to a ground location 24.

FIG. 2 shows a partial cross section of the largest pole member or section 16a. The spike 22 is buried in the ground to a certain height and the base stand 18 is supported a predetermined distance above the ground 24 to ensure proper drainage of water that may enter the top of the base stand during a rain or other similar weather condition. The lower most member 16a terminates in a downwardly extending rod 32 with a lower most circular bearing 34. A hole through the base stand side is threaded and the thumb screw 20 is inserted therein and turned until it touches the side of the rod 32. The thumb screw 20, which would engage the lower bearing 34 prevents the wave banner pole member 16a from pulling back out of the base stand 18 during windy conditions or someone pulling upwardly on the wave banner pole 16 who happens along. A pair of upper bearings 36 and 38 is mounted axially on the rod 32 at the upper end thereof to provide stability for the wave banner pole 16 when its lower section or member 16a is mounted within the base stand 18 by its rod 32 and its bearings 34, 36 and 38. The rod 32 is mounted to the bottom of section 16a through a cap plug 42 inserted into the bottom of the tubular section 16a and held in place by a rivet pin 40.

A bracket 26 is mounted around the pole section 16a to hold a spring biased clip 28 that is generally inserted into a grommet or other device at the bottom of the wave banner 12 to retain a wave shape bend 44 at the top of the wave banner 12. FIG. 3 shows a cross section of this bracket 26 and spring clip 28 and the ghosted movement directions that it may swing given different breezes when the wave banner and its wave banner pole are placed outdoors. FIG. 4 shows a cross section of the thumb screw 20 inserted into the holes through the tubular sides of the member 16a approaching rod 32 when screwed therein to hold the wave pole section 16a in place within the base stand 18.

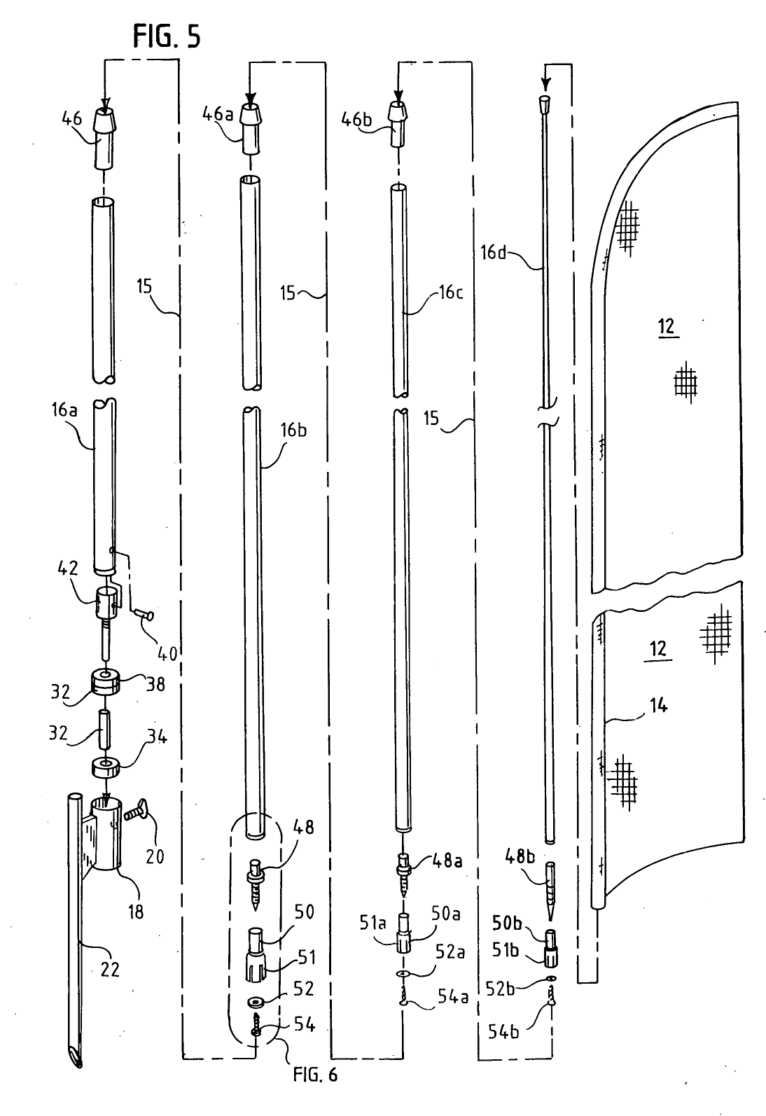

FIG. 5 shows from far left the assembly of the unique wave banner pole and its individual components therein. The unique combinations of elements for rotating the wave banner pole in 360° is shown clearly in the exploded view with interrelationship of the elements 18, 20, 32, 34, 36, 38 40, 42 and 16a all working cooperatively in a configuration permitting the rotation of the wave banner pole 16 within its base stand support 18 in a fixed relationship by the thumb screw 20 securing it in place therein.

FIG. 5 shows the wave banner pole hollow aluminum tubular members 16a, 16b and 16c in descending diameters with a fiberglass whip 16d of a lesser diameter than 16c and inserted therein. A member 16b which fits within larger member 16 adjacent thereto as shown by the assembly dotted line 15. Each member 16a, 16b and 16 includes a cap sleeve 46, 46a and 46b on the upper end of each member, respectively for receiving a member of a lesser diameter therein for the storage and extended use positions of the wave banner pole 16. For example, member 16b is inserted into 16a through the cap sleeve 46 and so on with whip 16d inserted through the cap sleeve 46b at the end of the storage of the wave banner pole 16. Thus the smaller in diameter member 16b is inserted through the cap sleeve 46 on the upper opening of the larger tubular member 16a and so on.

Next, each preceding member after 16a includes a frictional engaging mechanism shown as cap screws 48, 48a and 48b inserted into the bottom of tubular members 16b, 16c and 16d, respectively. Bushings 50, 50a and 50b having a lower slit portion 51, 51a and 51b, respectively, that flex radial outwardly from the axis of each pole member to frictional engage the inner surface of each tubular member encasing them causes the adjacent tubes to twist lock in place by turning the small member within the larger adjacent member causing the bushings 50, 51a and 52b to ride up the threads of screw caps 48, 48a and 48b, respectively, that flare out the slits 51, 51a and 51b radially against the inner sides of the larger tubular member when twisted in one direction to disengage the frictional mechanism of the bushing slits against the inner surface of the tubular members. Washers 52, 52a and 52b in cooperation with screws 54, 54a and 54b screw into the tips of screw caps 48, 48a and 48b to prevent the bushings from disengaging totally from the threads when twisting the opposite direction to unlock the twist lock of the members with respect to one another.

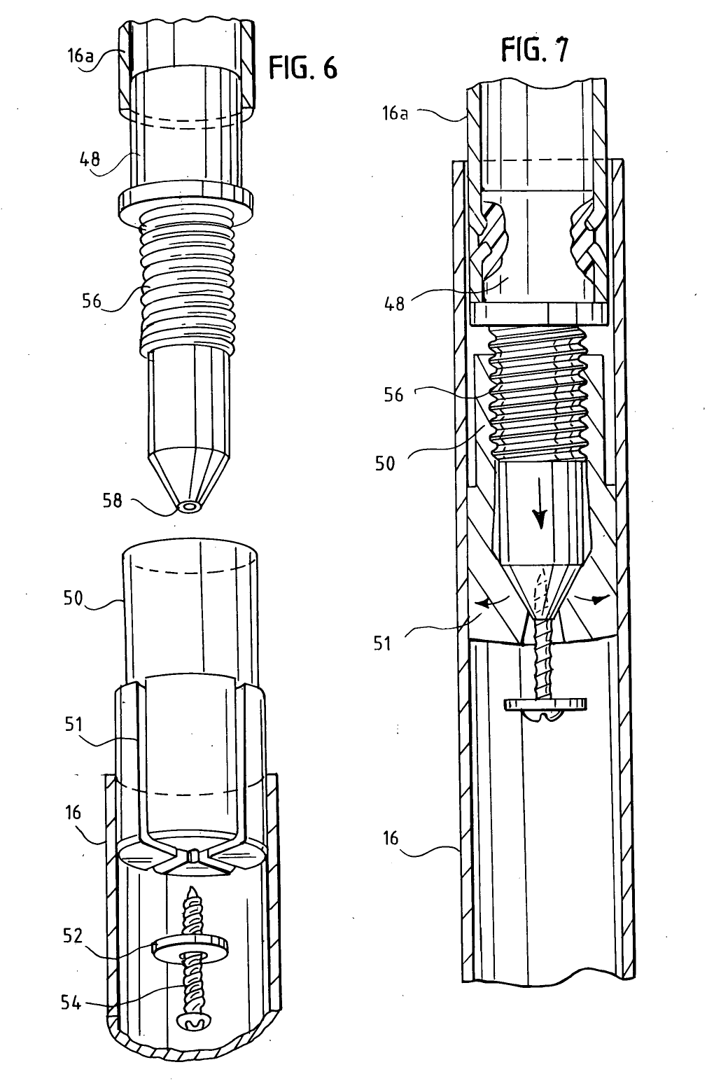

FIGS. 6 and 7, show in greater detail the movement of the bushing slits 51 against the inner surface of member 16 when member 16b is inserted therein and twisted to radially flare out the slits 51 of the bushing 50 against the sides of the larger tube to twist lock the tubular members at the predetermined desired length. In addition, the threads 56 of the cap screw 48 are shown in greater detail along with the retaining screw 54 engaging a screw hole 58 on the tip of the cap screw 48. This allows the wave banner pole to be generally extended to accommodate wave banners for 8′, 12′ and 15′ in length so that there is the large colorful wave banner to get the desired attention from the viewing public when an advertiser wants to make a statement that is hard to ignore when the wave banner is placed either indoors or outdoors near a business product or event being promoted.

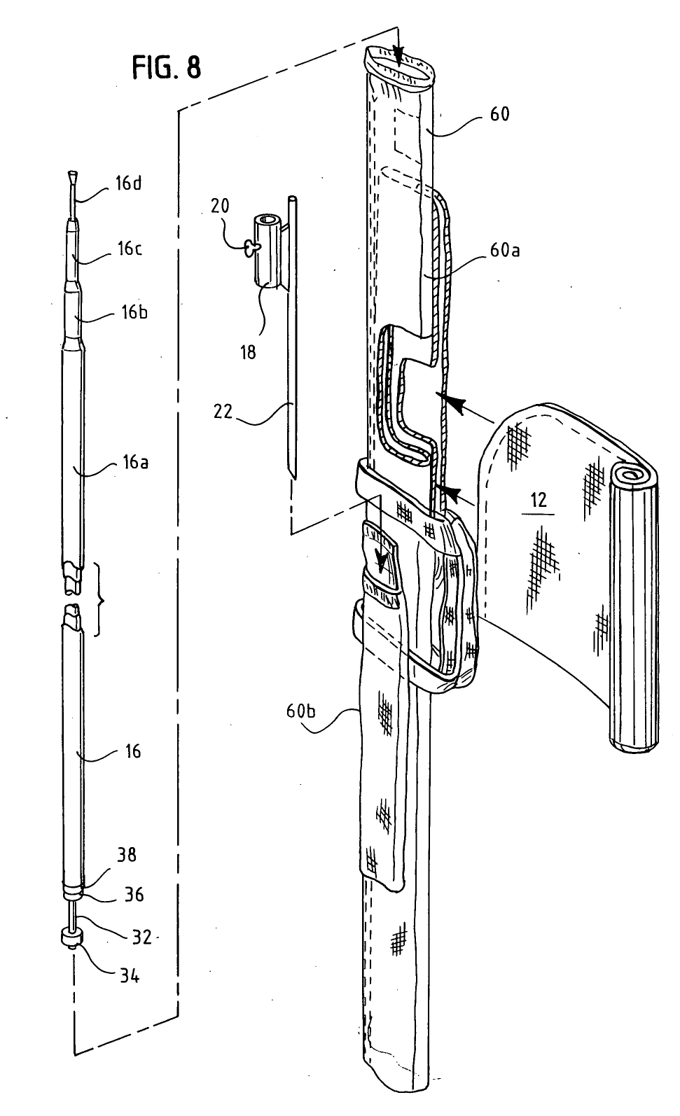

FIG. 8 shows the storage of the wave banner pole 16 and its wave banner 12 within a traveling case 60 having an opening at one end 60a with a touch closing material a base stand pocket 60b and a wave banner pocket 60c to carrying the wave banner pole 16 and wave banner 12 to a particular location for its display to the public

While the specific embodiments have been illustrated and described, numerous modifications come to mind without significantly departing from the spirit of the invention and the scope of protection is only limited by the scope of the accompanying Claims.

What is claimed is:

1. A wave banner and wave banner pole system for displaying ads or promoting events comprising:
a wave banner for promoting products or events having predetermined lengths;
a wave banner pole for mounting the wave banner thereon, said wave banner pole including:
a plurality of rigid hollow tubular interconnected telescoping members capable of concentrically being stored within each other of descending diameters with a fiberglass whip of a lesser diameter than the smallest diameter of the telescoping members and inserted therein and expandable to predetermined lengths to match the predetermined lengths of wave banner, each member including a first open end for inserting a smaller diameter member therein and a second opening for inserting a cap;
a frictional member attached to the bottom of each member except a largest tubular member for a twist lock engagement of each member inserted into the next larger tube for locking adjacent members together with respect to each other to form the predetermined length for the wave banner pole to match the length of the wave banner;
a rod affixed to the second opening of the largest diameter telescoping member of the wave pole extending axially downwardly therefrom a predetermined length;
a plurality of circular bearings axially mounted onto the rod at predetermined spaced apart relationship with respect to one another, the bearings axially mounted on the rod allow the rod to rotate 360° within the bearings;
a hollow base tube having a first opening configured to receive the diameter of the plurality of bearings in close engagement with an inner surface of the hollow tube, the hollow tube base having a stop at a second opening opposite the first opening to prevent the bearings and rod from passing all the way through the tube and to hold the wave banner pole fixedly in place; and
a stand rigidly affixed to the base tube for supporting the base tube in a generally vertical position to hold the wave banner pole with the wave banner in an upright position for displaying the relevant ad or promoted event.

2. The system of claim 1, where said wave banner for displaying ads or promotional events is made out of a 200 denier nylon and the ad display is screen printed single face reverse and includes a sleeve and a tie down member.

3. The system of claim 2, where said wave pole members are hollow aluminum tubular members in descending diameters with a fiberglass whip of a lesser diameter than the smallest diameter aluminum member, said whip is inserted in the smallest aluminum diameter member and bends to form the upper wave portion of the wave banner.

4. The system of claim 3, where said largest pole member includes a bracket secured to the outer surface of the member and includes a spring clip secured thereto for engagement with the tie down member of the wave banner to hold the wave banner in place on the wave banner pole.

5. The system of claim 3, where said the wave banner pole expanded to its predetermined length to match the size of the wave banner is inserted into the sleeve where the whip is bent during the tie down to the spring clip to form the upper wave portion of the wave banner and to secure the wave banner on the expanded wave pole.

6. The system of claim 3, where said circular bearings adjust the wave banner pole to turn the sleeve and the wave banner into incoming wind to remove the tension from the surface of the wave banner and to prevent the wave banner and wave pole from tipping over in gusts of wind.

7. The system of claim 1, where an advertisement content provider directs advertisement content to be displayed in colorful wave banner and the wave banner pole includes at least three bearings on the rod, with one bearing at the lower end of the rod and two closely adjacent bearings at the top end of the rod where it attaches to a cap pug inserted into the second opening of the largest pole member.

8. The system of claim 1, where said bearings includes:
a generally flat top surface and a generally flat bottom surface when axially mounted on the rod attached by the cap pug to the second end of the largest member; and
a pin extending through the side of the largest member to affix the cap plug securely to the second opening of the largest member.

9. The system of claim 1, where said stand further includes:
a vertical portion connected to the hollow base tube for supporting the base tube in a vertical position; and
a plurality of horizontally disposed feet extending from the vertical portion of the stand for stabilizing and supporting the stand during windy conditions.

10. A system for providing a support for a wave banner ad comprising:
a wave banner with a sleeve along one side thereof;
a wave pole configured to fit within the sleeve to support the wave banner in an upright position;
a rotating member connected to one end of the wave pole allowing a 360° rotation of the wave pole for constant visibility of the wave banner;
a base stand receiving the rotating member in a fixed relationship to secure the wave pole to either an indoor or outdoor display placement for ads or promotional event;
a bracket attached at the lower end of the wave pole; and
a tie down member affixed to a lower portion of the wave banner or sleeve including a clip member connecting the bracket to the tie down for forming the upper end of the wave banner into the wave form.

11. The system of claim 10, where said base stand includes a vertical spike for pounding into the ground to secure the base support of the wave pole.

12. The system of claim 11, where said wave pole consists of three telescoping interconnected rigid aluminum pole members with a fiberglass member at the end of the wave banner pole, each rigid pole members having a first and second opposing ends.

13. The system of claim 12, further including a frictional means at the second end of each rigid pole member and the whip except a largest pole member.

14. The system of claim 13, where said rotating member includes at least three circular bearing mounted in an axial arrangement with respect to the telescoping members and at the second end of the largest wave pole member.

15. The system of claim 13, where said tie down member is a grommet located on the lower end of the sleeve.

16. The system of claim 10, where said bracket allows the movement of the spring clip member to rotate around the pole members.

17. A method for providing a wave banner mounted on a wave pole comprising:
choosing a custom wave banner with a desired attention getting colors to be displayed;
receiving advertisement content from an advertising content provider;
printing said advertisement content onto the wave banner;
mounting the wave banner on a wave pole capable of rotating 360° for constant visibility of the ad or promotional event printed onto the wave banner; and
including bearings mounted within a base stand axially position on a portion of the lower most part of the wave banner pole to achieve the 360° rotation of the plow wind gusts of wind engage the wave banner to turn the wave banner into the wind to prevent damage of the wave banner.

18. The method of claim 17, further comprising removing original advertisement on the wave banner and replacing it with a second wave banner

19. The method of claim 17, further comprising selecting said advertisement content to insert into said wave banner based on intended end viewer.

20. The method of claim 17, further comprising selecting said advertisement content based on whether distribution of said wave banner on the wave pole is intended to be local, regional, or national.
